(19) United States
(12) Patent Application Publication
(10) Pub. No.: US 2003/0014644 A1
(43) Pub. Date: Jan. 16, 2003

(54) Method and system for security policy management

(76) Inventors: James E. Burns, Whippany, NJ (US); Aileen Cheng, Millington, NJ (US); Provin Gurung, Jersey City, NJ (US); Siva Rajagopalan, Morris Plains, NJ (US); Prasad Rao, Edison, NJ (US); Surendran Varadarajan, Edison, NJ (US)

Correspondence Address: Joseph Giordano, Telcordia Technologies, Inc., 445 South Street - 1G112R, Morristown, NJ, 07960, US

(21) Appl. No.: 10/137,795

(22) Filed: May 2, 2002

Related U.S. Application Data
(60) Provisional application No. 60/288,226, filed on May 2, 2001.

(51) Int. Cl. H04K 1/00

(52) U.S. Cl. 713/182

(57) ABSTRACT

The conformance of a network to a set of security policy statements is determined by attempting to violate the policies by routing packets through models of network elements. Policy statements specify whether a set of clients is granted or denied access to a network service offered by a set of servers. Network element models are in accordance to the element's configurable parameters and supported services, which together indicate how the element will treat packets when the element's current configuration is applied to the model. Conformance to a policy statement is determined by building a packet in accordance with the network service and a representative network-element client and server, and by attempting to move the packet from the client to the server by applying the packet to the network element models. Policy conformance is based on whether the packet reaches the service on the server. Network reconfigurations are determined for non-conformant policies.

### RELATED APPLICATION

The present application claims the benefit of U.S. Provisional Application Number 60/288,226 filed on May 2, 2001 entitled, “Automatic Network Management of Data Communications Networks.”

### GOVERNMENT RELATED RIGHTS

This invention was made with Government support under F30602-99-C-0182 awarded by the Department of the Air Force-Rome Laboratory. The Government has certain rights in this invention.

### BACKGROUND OF OUR INVENTION

1. Field of the Invention

Our invention relates generally to network security management. More particularly, our invention relates to the automated determination of network configurations that violate a given set of security policy statements and with the automated reconfiguration of the network to restore violated security policies.

2. Description of the Background

Network security is an increasingly important issue; however, it is becoming more difficult for a network administrator to manage network security. A primary factor contributing to this difficulty is the way in which security policies are defined and managed today. More specifically, an administrator manages a network through a set of security policies, which can be viewed as a set of network properties the administrator wishes to maintain in the network. However, rather than maintaining these policies as general properties or rules to which the network should conform, the administrator defines the policies today as event-condition-action rules or as network configurations, both of which methods tie the policies to the actual network and define the policies in terms of the network.

Specifically, automated tools provide event-condition-action rules that allow an administrator to define a set of measurable events and the reconfigurations that should take place when one of these events occurs. The problem with defining policies as event-condition-action rules is that the administrator must predict/foresee all possible events the given network may produce and must place actual network configurations within the rules, which configurations are tied to the current context of the network. In other words, these policies are defined with respect to the actual network and will need to change as the network changes. The other way administrators define policies is through actual network configurations that are required to implement the general properties behind the policies. For example, policies today are typically defined as packet filtering rules for firewalls and as other traditional security languages that make use of IP (internet protocol) addresses. As can be seen, the policies are again defined with respect to the underlying network topologies and network technologies making them directly tied to and dependent upon the network and the network changes. In general, because policies are defined in these manners, a given general policy ends up being expressed as numerous specific policies, which change each time something within the network changes.

Adding to this issue is the fact that networks today are changing on an almost daily basis. Network elements can be added and removed from the network, network elements can be upgraded adding more capabilities, networks can be merged with one another, network topologies can change, new services can be added, business relationships can change that result in new policies or cause existing polices to change, etc. Each of these changes essentially changes the “state” of the network and means that an administrator must study and reconfigure the network to ensure that the overall security policies are maintained and/or recovered. However, these responsibilities are made difficult by the fact that policies today are directly tied to and defined with respect to the actual network, and by the fact that networks are increasingly more complex and changing.

More specifically, defining policies with respect to the actual network means that each time a state change occurs, network architects and administrators not familiar with the prior policies must evaluate the current configurations and infer what policies these configurations were meant to uphold. Assuming the architects and administrators correctly perform this task, they must then examine the network changes to determine the issues they create and based on the inferred policies, make reconfigurations to maintain these policies. However, it is often difficult to determine the full scope of a change in network state and even more difficult to determine the interaction of one network configuration with another. As a result, errors are common creating unforeseen security gaps. Making these issues worse is that networks today often have several administrators, some for local sub-networks and some for the overall network, etc. and each administrator may have different policies. Because it is difficult to infer policies from configurations, it is difficult to ensure that reconfigurations at one level do not conflict with another level.

Many of these issues were not a problem for many years because network states changed at a very slow pace, once a month or so, and networks were small. Hence, administrators had time to study changes and ensure network integrity. However, today, networks change, grow, and merge on a daily basis and administrators do not have time to study changes. Changes need to be made frequently, quickly, and correctly.

### SUMMARY OF OUR INVENTION

It is desirable to have methods and apparatus that overcome the disadvantages of prior systems and that can monitor the state of a network and automatically react to state changes and determine the appropriate reconfigurations necessary to uphold security policies that reflect high level security goals rather than low-level configurations. It is also desirable to have methods and systems that can take a proposed network that is partially defined and generate a set of compliant network configurations for the implementation of that network.

In accordance with our invention, security policies reflect the intent of a security administrator and are defined separately and independently of the mechanisms used to implement that intent such that the policies can remain constant as the network state changes. Specifically, we define policy statements such that they are in a service access form: whether a “client” should be “denied/granted access” to a “service” being offered by a “server”. However, the policy statements do not specify actual clients, services, and servers, these being further defined through a mapping. As a result, the policy statements are abstracted from and have no direct tie to the actual network In further accordance with our invention, the conformance of a network to a given policy statement is determined by selecting a specific client and server as specified by the policy statement, by defining a specific packet in accordance to the selected client, server, and service as defined by the policy statement, and by attempting to hop/move the packet from the client through the network elements that comprise the network to the server by using the “capabilities or services” supported by the network elements. In order to perform this operation, the network elements are modeled according to the services they support. Specifically, the network element services are modeled according to the set of possible configuration parameters the network element supports and according to packet transfer/transformation rules, which describe how a packet is treated as it passes through the network element in accordance with the services offered by the element. By knowing the current configuration of a network element and the packet transfer rule, the configuration can be applied to the configuration parameters and to the packet transfer rule to determine the behavior of the network element with respect to a specific packet on a specific interface.

Hence, policy violations are determined by deriving the current behavior of the network by putting together the service models of the network elements that comprise the network and by applying the current state/configuration of the network to these elements. Then, given a specific client and server, an attempt is made to hop a specific packet from the client to the server using the services of the network elements to determine if the client can access a service offered by the server as described by the policy statement.

For a policy statement that indicates a client should be granted access to a server/service, an attempt is made to move a packet from the client to the server in accordance with the normal operation of the service. All possible routes are attempted. If the packet reaches the server, the policy statement is deemed met, otherwise, the policy statement is deemed violated. For a policy statement that indicates a client should be denied access to a server/service, an attempt is made like above to move a packet from the client to the server in accordance with the normal operation of the service. However, with service denial, the assumption is not only that a client may attempt to access a server under normal operation, but may also try to combine several services together to reach the server. As such, an attempt is also made to reach the server from the client by moving combinations of packets through the network, each packet being representative of the different services. Again, all possible routes are attempted and if the packet reaches the server, the policy statement is deemed violated, otherwise, the policy statement is deemed met. Based on the nature of the policy violation, reconfigurations are also determined to make the network conformant with the policy statements.

In a first specific embodiment of our invention, the conformance of a network to a set of policy statements and the set of possible reconfigurations that make this network conformant to these policy statements are reported to a network administrator. Importantly, the network being analyzed can be an actual network or a proposed network, in which case our inventive systems and methods determine a set of network configurations that can be used to implement the proposed network and that make this network conformant with the policy statements.

In a second specific embodiment of our invention, out inventive methods and systems are integrated with a network configuration management system that is able to monitor network states and perform network configurations. In this embodiment, the network configuration system provides our inventive system with the current state of a network. Our inventive system then determines the conformance of this network to a set of policy statements and provides the configuration management system with a set of reconfigurations that will make the network conformant with any violated policies. The resulting network state can then once again be analyzed by our system. The advantage of this closed-loop configuration is not only the ability to dynamically/automatically monitor the state of a network and to correct security violations as they occur, but also the ability to automatically determine if the correct reconfigurations were made and to ensure that the network state has not further changed making these new reconfigurations incorrect, all with minimal or no human interaction.

### BRIEF DESCRIPTION OF THE DRAWINGS

FIG. 1 shows a first illustrative embodiment of our security management system invention for determining whether a set of security policy statements are met by a network configuration and for proposing a set of reconfigurations in the event the network does not meet the policy statements, which reconfigurations will make the network conformant.

FIG. 2 shows a second illustrative embodiment of our security management system invention as shown in FIG. 1 now integrated with a configuration management system that controls and monitors a network, which integration allows the security management system to dynamically receive network state information from the configuration management system and to automatically provide the configuration management system with network reconfigurations in the event the network does not meet a set of policy statements.

FIG. 3A depicts an illustration of a network comprising both web-servers, providing a web-service, and clients, comprising both paid and unpaid-subscribers to the web service, and wherein FIG. 3B shows an illustrative policy statement in accordance with our invention wherein the policy statement here conveys the intent to grant paid-subscribers access to the web-service offered by the web-servers.

FIG. 4 shows an illustrative example of our inventive method for determining whether a network satisfies a policy statement, which method includes attempting to transfer packets from clients to servers through service models of network elements, the models being configured according to the current state of the network.

### DETAILED DESCRIPTION OF OUR INVENTION

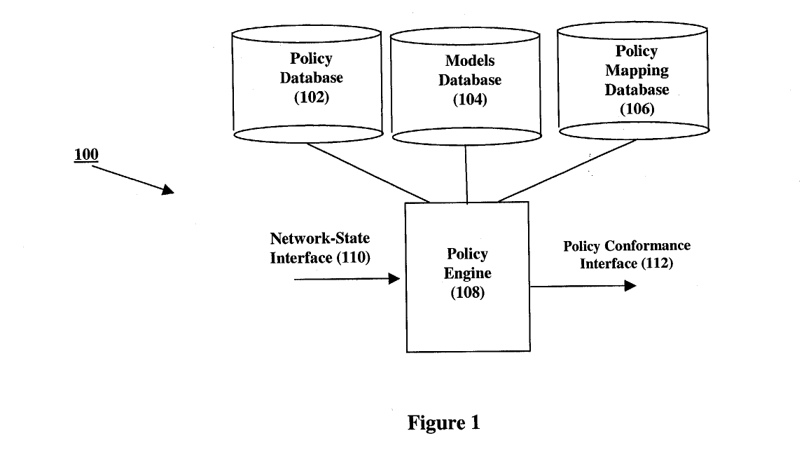

FIG. 1 shows a first illustrative embodiment of our security management system invention 100 for managing security policies in dynamically changing networks that comprise routers, firewalls, switches, client-based machines, such as personal computers (PC), server-based machines offering services to the network, etc. Broadly, our invention comprises a policy database 102, a models database 104, a policy mappings database 106, a policy engine 108, a network-state interface 110, and a policy conformance interface 112. Policy database 102 comprises a plurality of security policy statements, in accordance with our invention, which an administrator wishes to enforce within a network. As is further described below, the policy mappings database 106 aids in the interpretation of these policy statements. Network-state interface 110 is an interface, including a computer console, a database, and/or an interface to an external system, for specifying the current state of a network. Network state information can include the network elements comprising the network, the element type of each network element, network element configurations (e.g., number of interfaces, services executing on the network element, configurable parameters on the element, etc.), the physical connectivity between pairs of interfaces of the network elements, the IP addresses associated with the network elements, routing tables, firewall filter tables, etc. Policy engine 108, in conjunction with the models database 104, is a logical system that can be implemented, for example, on one or more computers and that takes the state of the network from network-state interface 110 and the policy statements from policy database 102 and determines, in accordance with our invention, whether the network is consistent with the policy statements. If one or more policy statements are not met, the policy engine 108 reports the condition on policy conformance interface 112, which may be a console, database, and/or interface to an external system. In a further embodiment of our invention, policy engine 108 also computes network reconfigurations that would make the network reported on network-state interface 104 conformant with the policy statements. The network reconfigurations include settings for configurable parameters within the network elements.

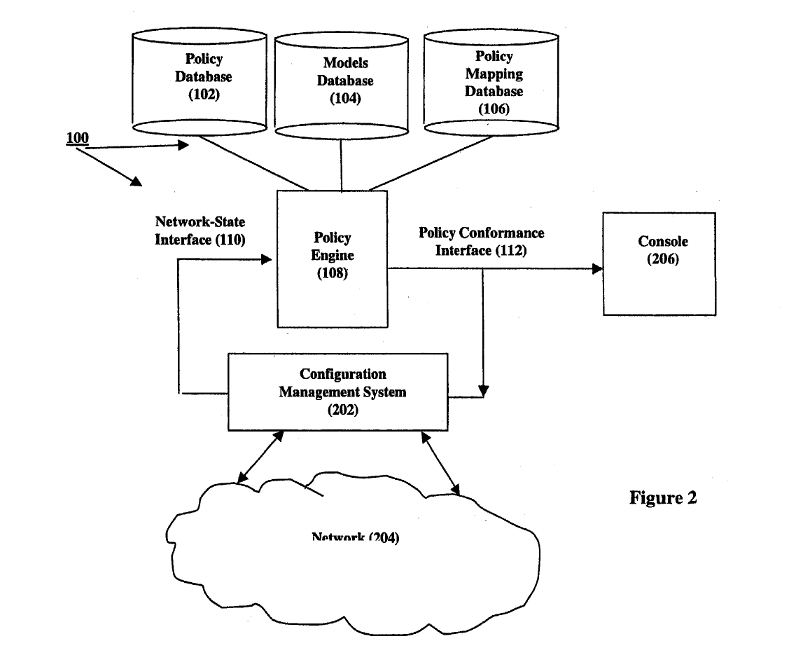

In accordance with these capabilities, FIG. 2 shows a second specific embodiment of our invention where the system of FIG. 1 is integrated with a configuration management system/systems 202, such as NESTOR developed by Columbia University, which are capable of monitoring/determining the state of a network 204 and are capable of configuring the network 204. In this arrangement, our inventive security management system provides dynamic security management for network 204. Specifically, configuration management system 202 provides system 100 with the current state of the network 204 through network-state interface 110. Upon receiving the network state, policy engine 108 determines if this state contradicts any of the security policy statements as specified in policy database 102. Uniquely, this determination is made by examining the current network state as reported on the network-state interface and does not require the policy engine to examine prior network states. If the policy engine determines a contradiction exists, it can report the condition to an administrator through console 206. In addition, policy engine 108 can also compute a set of reconfigurations that are necessary to make the network 204 conformant with the policy statements and can pass these reconfigurations to configuration management system 202 for implementation within network 204.

The advantage of our inventive security management system 100 integrated with a configuration management system 202 is the ability to dynamically monitor the state of a network and to correct security violations as they occur. Uniquely, our inventive system can also verify the correctness of these reconfigurations. Under the prior art, changes are made to the network with the assumption that the changes resolve the security issues and with the further assumption that the network state has not further changed since the reconfigurations were determined. In accordance with our invention, configuration management system 202 can once again provide system 100 with the current state of the network after the reconfigurations are made. Again, system 100 can determine if there are any inconsistencies between the network state and policy statements. The advantage of this closed loop system is not only the ability to determine if the correct reconfigurations were made, but also to ensure during the time a network state is being examined and reconfigurations computed, the state of the network is not further altered by some other administrator or by an external event that makes further reconfiguration necessary.

There are several additional benefits of our inventive system 100. First, policy engine 108 is not tied to a specific network form/definition that it has priorly defined/created. As a result, in addition to analyzing current networks and making then conformant to a set of policies, our inventive system can also be used to build networks by providing policy engine 108 with a partial network definition and by letting the policy engine determine a set of configurations that would make the network conformant with a set of policies. Hence, our inventive system can also act as a network-planning tool. A second advantage is that policy engine 108, when comparing a set of policies to a network state, can determine if a set of policy statements are consistent among themselves. A third advantage, as indicated earlier, relates to the fact that multiple administrators now often administer networks. Administrators can continue to administer a piece of the network while our inventive system ensures global policies are still met.

Reference will now be made to the policy statements maintained in policy database 102. As mentioned earlier, as a network changes state today, administrators must reconfigure the network in order to maintain or recover some general network property. We refer to this property to be maintained as an “invariant”, which are the policy goals that an administrator wishes to enforce in an otherwise changing network and that should remain constant as the network state changes. Hence, in accordance with our invention, the invariants define the intent of the administrator and importantly, are defined separately and independently of the mechanisms (e.g., network configurations) used to implement that intent.

Separating the goal of a policy from the implementation of the policy has several significant advantages. First, as the state of the network changes (i.e., the network topologies, technologies, services, etc.), the policy goals remain constant while the network configurations used to meet these policies change. Second, as compared to the event-condition-action method of defining policies, our way of defining policies does not attempt to foresee all possible new events that may occur. Rather, in accordance with our invention and as further defined below, we dynamically determine whether a new network event matters by determining its impact against the specified policies. In other words, by having policies that state assertions that are meant to hold true, new network events can be compared against these policies to determine their consequences. If the network event has no effect on the policies, it can be ignored. Today, there is no easy way to determine the consequences of new events. In addition, rather than defining a set of static actions that are tied to a specific network context, we dynamically determine a set of actions based on the impact of a network event against the policies. Under the prior are if a network state changes, the static actions in response to an event may no longer be appropriate. However, in accordance with our invention, the actions are always based on the current network state as compared to the policies. In effect, by having a general policy goal, a determination can be made as to whether a certain network state meets or does not meet that goal, this comparative analysis being the foundation of the policy engine 106 as further described below.

In accordance with our invention, all invariants/policy goals are described by specifying a “client”, a “server”, a “service”, and “denial/grant of access”, this being the form for each policy statement maintained by database 102. This designation means that the specified “client” should be “denied/granted access” to the specified “service” being offered by the specified “server”. Another way of stating this is that we express policies in terms of access (both positive and negative) to applications and services offered by network elements (i.e., servers). However, we also take one additional step. Rather than stating policy statements as specific clients, servers, and services, the policy statements are specified using abstract “tag-names”. Mapping database 104 maintains a mapping that describes the specific members (network elements) associated with each client and server tag-name and maintains a detailed description of the service specified by the service tag-name. Again, this approach separates the policy statements from the implementation of the network and allows policies to remain static while the state of the network changes. For example, if a server or client is added or removed from the network, the policy statements stay constant while the mappings change.

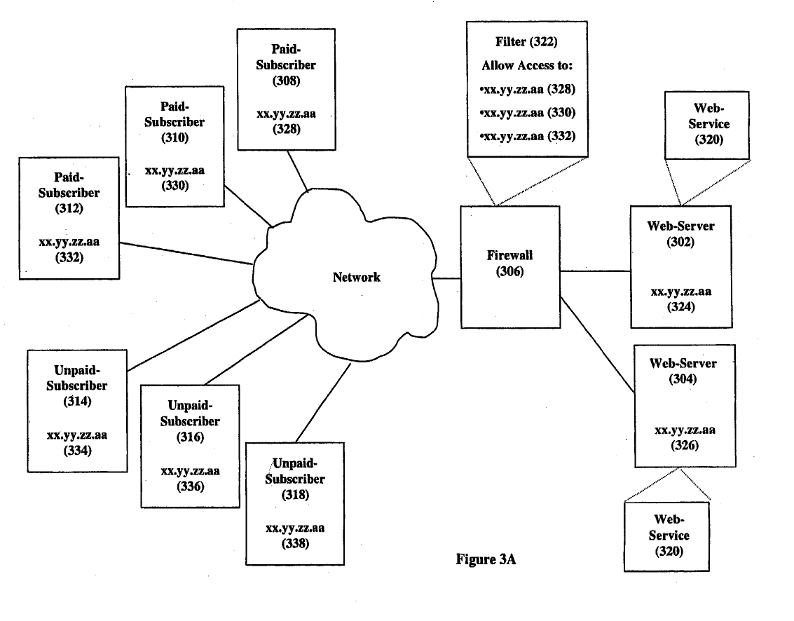

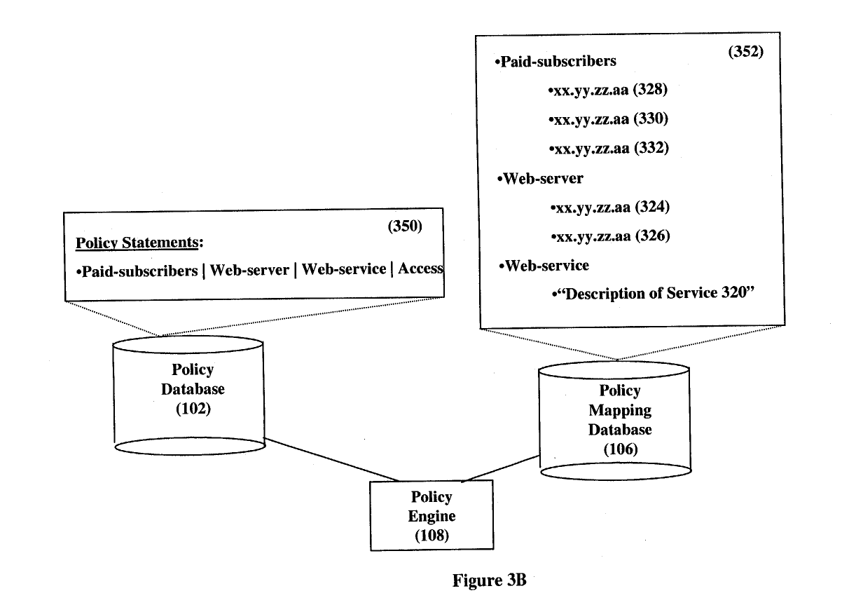

FIG. 3A shows a network to further illustrate how we specify policies as compared to how policies are specified under the prior art. Web-servers 302 and 304 reside behind firewall 306 and each provides a web-service 320 to paid-subscribers 308-312, but not to unpaid-subscribers 314-318. As an example, a firewall filter 306 that allows subscribers 308-312 through the firewall can be used to provide and deny access to service 320 provided by each server. Assuming web-servers 302 and 304 are assigned IP-addresses 324 and 326 respectively, paid-subscribers 308-312 are assigned addresses 328-332 respectively, and unpaid-subscribers 314-318 are assigned addresses 334-338 respectively, the filter 322 would specify that addresses 328-332 are allowed to pass through. Under both the prior art and our invention, firewall 306 could be used to implement the general policy that certain network elements should be granted/denied access to the web-servers. However, under the prior art, this policy would actually be defined/stated as filter 322, that IP addresses 328-332 are allowed to pass through the firewall, which filter is the result of the general policy and not the general policy itself. However, in accordance with our invention and as shown in FIG. 3B, the policy statement 350 as maintained by policy database 102 is defined as: the clients represented by the client-tag, “paid-subscribers”, are granted access to the service represented by the service-tag, “web-service”, executing on the servers represented by the server-tag, “web-server”. Mapping database 106 would then maintain a mapping 352 that relates “paid-subscribers” to IP addresses 328-332, that relates “web-server” to IP addresses 324 and 326, and that would define “web-service”. Importantly, policy statement 350 contains no information specific to the network and rather than it stating the result of the policy (i.e., firewall 322), it states the general policy.

As a further example, to now allow access to unpaid subscriber 314, the filter 320 could be updated to include IP address 334, which reconfiguration would occur under both our invention and the prior art. However, because the prior art defines policies as configurations, the policy definition has changed because the filter configuration has changed. However, in accordance with our invention, the policy statement 350 remains static and the mapping 352 simply changes to include IP address 334 as a member of “paid-subscribers”.

As described, mappings database 106 provides a definition for the abstract tag-names of the policy statements. With respect to client and server tag names, the corresponding mappings database definition is any physical characteristic that can be associated to network elements. Hence, the definition can be a set of specific IP addresses as in the example above, can be a range of IP addresses, can be a characteristic such as any device executing a particular operating system version, etc. As for the service-tag name, the mappings database provides one or more definitions of how that service can be implemented. As is further described below and in accordance with our defining policies as “access to services”, we examine policy statement conformance by attempting to move IP packets from clients to servers in accordance with the policy statement definition. As a result, the mappings database defines services with respect to packet movement. For example, the service tag-name may correspond to a telnet service, in which case the mappings database may define the service as any IP packet with a destination port corresponding to telnet. However, services can also be accessed illegally. For example, ftp is available between a client and server if telnet is available between the client and some intermediary network element and ftp is available between this network element and the server. As such, the mappings database will define ftp not only as any IP packet with a destination port corresponding to ftp, but also as a combination of IP packets, first corresponding to telnet, and then to ftp. This concept is further clarified below.

Reference will now be made to the policy engine 108 and to the models database 104, which maintains network element models used by the policy engine to determine policy conformance. The purpose of the policy engine is to determine if a network state provided through network-state interface 110 violates a security policy statement, and to determine possible reconfigurations of the network to restore the policy. As described earlier, policy violations can occur when the physical network topology changes, when a network element configuration changes, when a network element is updated or added to/removed from the network, when a service provided by a network element changes, etc., all of which alter the network state. In general, the policy engine can determine two types of policy violations. The first type is whether two policy statements contradict each other. The policy engine cannot automatically resolve this type of violation but rather, can only report it to an administrator. The second type of violation is whether the service mandated or forbidden by a policy statement is available. More specifically, this second category can be further divided into three types of violations. First, the policy engine will detect a policy violation if a service mandated by a policy is unavailable because the network cannot support the service. This type of violation occurs, for example, if a physical path does not exist between a “client” and “server” or if a required service between a “client” and “server” is not provisioned on a network element. The policy engine again can only report such violations, but not automatically resolve these violations because they are not of a type that can be controlled by a configuration management system. Second, the policy engine will detect if a service mandated by a policy is unavailable because of a mis-configured network element, such as a router. Because a configuration issue that can be controlled by a configuration management system causes this violation, the policy engine is capable of automatically determining and resolving this violation. Finally, the policy engine will detect if a service forbidden by a policy is available, and further, will detect each way in which the service may be available (e.g., there may be two distinct paths between a client and server that gives the client access to the server. The policy engine can detect both paths). Again, the policy engine can automatically resolve these types of violations.

As mentioned above, the policy engine determines if policy statements are upheld by trying to move (or hop) specific packets (i.e., packets with specific IP addresses, port numbers, payloads, etc.) from a specific client through the network elements that comprise the network to a specific server and service by using the “capabilities or services” supported by the network elements and as indicated by the current state of the network. For example, using FIG. 3A, assume the policy statement is that paid-subscribers are allowed to telnet to a web-server and that the paid-subscribers and web-servers are as shown in FIG. 3B. In order to determine if this policy is supported by the network, the policy engine will choose a paid-subscriber, such as subscriber 308, and a web-server, such as 302, and will attempt to “hop” a telnet packet from subscriber 308, through the routers that may comprise the network, through firewall 306, and to server 302 based on the network state. The success or failure of the operation determines if the network meets the policy statement.

In order to perform these types of operations, the policy engine relies on network element models, which are maintained in the model database 104, and that represent the interaction of a network element with the services offered by that network element. Two points should made. First, network models are generic in that they represent types of equipment and if necessary may correspond to a specific vendor; however, the models do not correspond to a specific network. The policy engine associates an appropriate model to each network element of a network. Second, the word “service” has a slightly broader meaning than as used above with respect to policy statements. As described, services are something provided by a server that an administrator is trying to deny or grant a client access to. However, all network elements provide services. For example, routers provide a routing service, firewalls provide a filtering service, personal computers and servers support telnet, rlogin, ftp, types services etc. Again, these may all be services an administrator is attempting to control access to on a server. But these are also services that can be used by a client to intentionally or unintentionally gain access to a server. It is this latter notion that is relevant to the policy engine in trying to move packets across a network.

With that said, for each service that can be offered by a network element, there is a corresponding model that reflects/captures the normal operation of that service. However, it should be noted that the network element service models can also reflect “abnormal” operation of the service. Specifically, if a security flaw is discovered in a service, the model can be changed to reflect this abnormal operation. Uniquely, this allows the policy engine to take into account the security flaw when determining if a network is conformant with the policy statements. As mentioned above, a model of a router, for example, reflects the routing service and the model(s) of a network server or personal computer reflect services such as ftp, telnet, etc.

We model these network element services according to the set of possible configuration parameters the network element supports and according to a concept we refer to as packet transfer/transformation rules. The configuration parameters of a network element have known values (i.e., the possible values for each parameter form a bounded set that is maintained by the policy engine) and include parameters that the policy engine will examine during the analysis of policy statements and that the policy engine will alter in order to make a network conformant with these statements. The packet transfer/transformation rules are rules that describe how a packet is treated as it passes through the network element. By knowing the current configuration (i.e., current state) of a network element and the packet transfer rule, the configuration can be applied to the configuration parameters and to the packet transfer rule to determine the behavior of the network element with respect to a specific packet (i.e., a specific header and possibly a specific payload) on a specific interface. Hence, the policy engine will take a specific packet and apply it to a packet transfer rule and based on the current configuration of the network element, determine how the network element will treat that packet.

For example, a packet transfer rule for a router is that a packet entering an input interface can exit from an output interface if there is an edge between the two interfaces. Given this rule, the current configuration of the router, and a specific packet on a particular input interface, the policy engine can determine if a packet will be dropped by the router or directed to an output interface and in particular, which one. A similar type of analysis occurs for a firewall except that a packet exiting the firewall may be transformed with a new IP address and/or port number in accordance with the firewall configuration. With respect to an intermediate network element (i.e., a network element other than the client and server being analyzed), telnet service, for example, may be modeled as, “any packet with a destination port of 23 should be granted access.” Given this rule and the intermediate network element's current configuration (i.e., is the telnet service running), the policy engine can determine if a packet should be granted access to the element or dropped.

Reference will now be made to the specific algorithm used by the policy engine to determine if the policy statements maintained by the policy database are violated by the current state of a network. Again, our inventive method for determining policy violations is to derive the current behavior of the network by putting together the service models of the network elements that comprise the network and by applying the current state/configuration of the network to these elements. Then, given a specific client and server, the policy engine attempts to hop a specific packet from the client to the server using the services of the network elements to determine if the client can access a service offered by the server as described by the policy statement.

As indicated earlier, the policy engine begins by receiving the current state of the network through network-state interface 110. This state will include the network elements and their types, the services and capabilities supported by these elements, the current setting for configurable parameters, and each element's neighboring network elements, etc. Using this information, the policy engine then constructs a network connectivity graph of the network (i.e., the network topology). Again, the policy engine does not rely on prior state information, including prior topologies. Once having this basic information, the policy engine proceeds to cycle through the policy statements one-by-one to determine if each statement is upheld. The policy engine verifies policy statements by attempting to break the policy. In other words, if the policy says to deny access to a service, the policy engine attempts to find ways to gain access to the service. Similarly, if the policy statement says to grant access, the policy engine attempts to determine if access is denied.

For each policy statement, the policy engine first uses the mappings database to determine the specific clients and servers to which the policy corresponds, to determine the specific service as designated by the service-tag, and to determine whether the specified clients should be denied or granted access to this service. Next, the policy engine attempts to hop a packet between combinations of designated clients and servers, with the intent of trying all combinations. However, trying all combinations could be computationally exhaustive. Instead, the policy engine simplifies the number of combinations by categorizing the clients into groups of similar members (similarly for the server members) and then by choosing one representative member from each category. The clients are categorized based on network routing; in other words, all clients that will be treated identically from a network routing point of view are placed in the same category. This determination can be made by collectively examining the routing tables of the network routers. In the worst case, all clients are treated separately. The servers are also categorized with respect to network routing and are further categorized based on the services each supports (this latter determination is made by examining the configuration of each server). Once having the categories and a representative member from each category, the policy engine then analyzes each combination of a representative client and server by hopping a packet from the representative client to the representative server to determine if the policy statement is violated. Importantly, the policy engine does this through transitive closure, in other words, all possible routes are attempted.

The method employed by the policy engine to verify a policy statement is different depending on whether the specified service is to be granted or denied access to the client. Beginning with grant of access, the policy engine chooses a representative client and server and builds a packet that represents the service the client is supposed to be able to access on the server (e.g., appropriate IP addresses/ports and packet payloads are chosen). Again, the mappings database provides the service definition from which the policy engine can determine how to build the packet. Note that if the client supports multiple interfaces, an interface is chosen and the packet appropriately formed. Having the packet, the policy engine uses the network graph to determine the client's neighboring network element on the chosen interface and determines how this network element will treat the packet by applying the packet to the network element's service model given the network element's current state/configuration. For example, assuming the network element is a firewall or router, a determination is made as to whether the packet is dropped or passed through, and if passed through, onto which interface and in what transformative form. Assuming the packet is passed through the network element, the policy engine applies it to the service model of the next corresponding network element as indicated by the network graph. This process is continued until the packet is dropped by a network element, it terminates at a server other than the desired server, or terminates at the desired server.

If the packet reaches the desired server and service, the policy engine next determines if the service requires information to be sent back to the client (this information is provided by the definition of the service per the mappings database). If the service requires reverse access, the policy engine next attempts to return an appropriate packet along the access path back from the server to the client by once again applying the packet to the network element service models. If the packet can be routed back to the client, the policy is deemed met.

However, if either the forward packet fails to reach the server or the return packet fails to reach the client, the policy engine attempts to route the packet (and the return packet) between the client and server along an alternate path if such a path exists. For example, the client may have multiple interfaces, in which case, a different interface is attempted to reach the server. If the designated server is never reached (or a required packet cannot be returned), the policy is deemed violated.

Regardless of whether the representative client can access the service on the representative server, all combinations of representative clients and servers for a given policy statement are attempted as just described. This not only ensures that the policy is met, but allows the policy engine to determine all possible violations. Once all combinations are attempted, the policy engine chooses the next policy statement from the policy database.

As described earlier, the policy engine can simply report policy violations on policy conformance interface 112. However, in accordance with our invention, the policy engine can also determine network element reconfigurations that will make the network conformant with a policy statement. Specifically, if the policy engine is not able to reach a server and a policy statement is deemed violated, the policy engine can examine the network element(s) where the packet stopped and determine what configurable parameters can be altered to allow the packet to proceed. The policy engine is able to make this determination because of the way we model network elements—as a list of configuration parameters that have a bounded set of values. As a result, there are a limited/set number of ways that can be employed to allow a packet to pass through a network element (or not pass through). Note that in addition to determining a new configuration, the policy engine also considers the configuration with respect to the total context of the network element. For example, a new firewall filter must be considered with respect to the current filters.

If a configuration is found for a network element that allows the packet to proceed, the policy engine once again attempts to hop the packet to the server. Importantly, if the configuration makes the network conformant with the policy statement, the policy engine uses the new configuration and re-tests prior policies that were deemed met to ensure the reconfiguration has not caused the network to become non-conformant with a policy. In the event this occurs, the policy engine will make further reconfigurations as needed. Additionally, all successful reconfiguration changes are used in the subsequent analysis of policy statements. As a result, the policy engine is able to determine the interaction of policies. Importantly, this process of changing configurations and rechecking policies may result in an endless loop, in which case the policy engine concludes that there may be conflicting policy statements.

Reference will now be made to those policy statements where service should be denied. As just described, the policy engine determines service access by using the required service as a user would expect to use the service. The definition of the service per the mappings database reflects this normal operation. For example, if a client should be allowed to ftp a file from a server, that ftp session should occur directly between the client and server. However, with service denial, the assumption is not only that the client may try to directly establish an ftp session with the server, but may also try to compose/combine several services together to reach the server. The example mentioned earlier was that ftp is available between a client and server if telnet is available between the client and some intermediary network element and ftp is available between this network element and the server. As a result, the mappings database may contain several definitions for a service to be denied access to—one definition includes normal operation of the service, and several definitions may define abnormal operation of the service, these definitions specifying combinations of services. The policy engine analyzes each of these definitions.

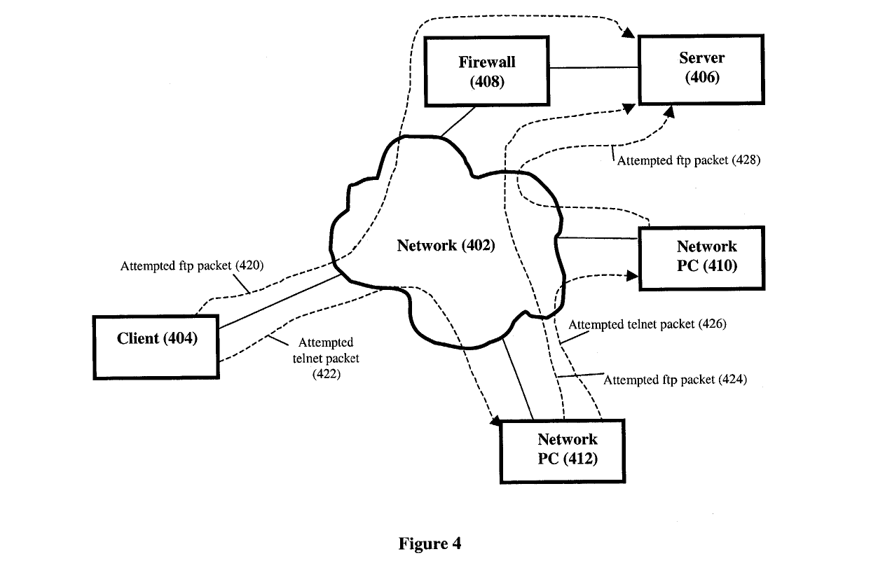

With that said, the policy engine will perform several types of analysis in an attempt to reach a server and violate a policy statement. First, the policy engine will proceed similar to above and attempt to treat the service under normal operation by hopping a packet from a representative client to a representative server. Again, the policy engine will attempt to hop the packet to the server using all possible routes. If one or more routes reach the server, the policy statement is deemed violated. An example of this analysis is shown in FIG. 4. Assume the policy statement is that client 404 should be denied ftp access to server 406, which resides behind firewall 408. As shown by packet 420, the policy engine will first attempt to correctly use the ftp service by attempting to route an ftp packet through the network 402, through firewall 408, and to server 406.

Once normal methods are exhausted, the policy engine next tries to reach the representative server using combinations of services as indicated by the mappings database. Here, the policy engine first determines which network element services can be used in combination to achieve the desired service. With that determination made, the policy engine generates from the representative client, along each route emanating from the client, all possible packets from this determined set of services. Whenever a packet reaches a server other than the desired server, the same generation of packets occurs again (except when the next hop is the desired server, in which case the packet corresponds to the desired service). If the server is reached, the policy is violated. Again, note that all combinations of paths and services between a representative client and server are attempted; and in general, this method of traditional packets and combinations of packets is repeated for all combinations of representative clients and servers for the given policy statement.

The example in FIG. 4 also shows this combinational approach. As indicated, ftp service could also be achieved through a combination of telnet and ftp, as an example. Hence, the policy engine will hop a telnet packet 422 from client 404 through network 402 to network PC 412. From network PC 412, the policy engine will next attempt to hop an ftp packet, 424, to server 406 in violation of the policy. The policy engine will also attempt to hop a telnet packet 426 from network PC 412 to network PC 410, and then an ftp packet 428 to server 406, again, in violation of the service. If any of the combination approaches succeeds in reaching server 406, the policy statement is deemed violated. (Note that FIG. 4 does not show all possible combinations of services to reach server 406).

Similar to policy statements designating grant of access, if a policy statement designating denial of access is deemed violated, the policy engine can again report the condition and/or attempt to determine network configurations that will make the network conformant with the policy statements. Here, the policy engine starts with the client and determines if the first hop after the client can be reconfigured to stop the service (based on how it was broken). If this is not possible, the next network element in the path is examined, etc. Again, once a reconfiguration is determined, all prior policies are reexamined.

Once all policy statements are examined, the policy engine reports on conformance interface 112 either the status of the network and/or the total configuration required to make the network conformant with the policy statements. As discussed with respect to FIG. 2, policy engine 106 may receive network state information from a network management system. If the policy engine reports a new configuration, this configuration can then be passed back to the network management system for the automated reconfiguration of the network. Again, the advantage of this closed-loop configuration is not only the ability to dynamically monitor the state of a network and to correct security violations as they occur, but also the ability to determine if the correct reconfigurations were made and to ensure that the network state has not further changed making these new reconfigurations incorrect. As also described earlier, a proposed network with partial configurations can be passed to the policy engine. In this case, the configurations produced by the policy engine can be used by a network administrator to build the network.

The above-described embodiments of our invention are intended to be illustrative only. Numerous other embodiments may be devised by those skilled in the art without departing from the spirit and scope of our invention.

We claim:

1. A method for determining whether a network comprising a plurality of network elements is conformant to a policy statement, wherein the policy statement indicates whether a set of clients is denied or granted access to a network-service supported by a set of servers, the method comprising the steps of:
building a topology and model of the network, wherein said model comprises a plurality of service models corresponding to the network elements, and wherein said service models indicate how the network elements will treat network packets,
identifying a first network element from the set of clients and a second network element from the set of servers,
building a packet in accordance with the network-service and the identified first and second network elements,
attempting to move the packet from the first network element to the second network element by applying the packet to the network element service models, and
based on whether the packet reaches the server, indicating whether the network is conformant to the policy statement.

2. The method of claim 1 wherein if the network is not conformant to the policy statement, determining a network configuration to make the network conformant to the policy statement.
